(19) United States
(12) Patent Application Publication
(10) Pub. No.: US 2012/0234807 A1
(43) Pub. Date: Sep. 20, 2012

(54) LASER SCRIBING WITH EXTENDED DEPTH AFFECTATION INTO A WORKPLACE

(75) Inventors: Jeffrey P. Sercel, Hollis, NH (US); Marco Mendes, Manchester, NH (US); Mathew Hannon, Bedford, NH (US); Michael von Dadelszen, Merrimack, NH (US)

(73) Assignee: J.P. SERCEL ASSOCIATES INC., Manchester, NH (US)

(21) Appl. No.: 13/422,190

(22) Filed: Mar. 16, 2012

Related U.S. Application Data
(63) Continuation-in-part of application No. 12/962,050, filed on Dec. 7, 2010.
(60) Provisional application No. 61/267,190, filed on Dec. 7, 2009.

(51) Int. Cl. B23K 26/38

(52) U.S. Cl. 219/121.69; 219/121.68

(57) ABSTRACT

Systems and methods for laser scribing provide extended depth affectation into a substrate or workpiece by focusing a laser beam such that the beam passes into the workpiece using a waveguide, self-focusing effect to cause internal crystal damage along a channel extending into the workpiece. Different optical effects may be used to facilitate the waveguide, self-focusing effect, such as multi-photon absorption in the material of the workpiece, transparency of the material of the workpiece, and aberrations of the focused laser. The laser beam may have a wavelength, pulse duration, and pulse energy, for example, to provide transmission through the material and multi-photon absorption in the material. An aberrated, focused laser beam may also be used to provide a longitudinal spherical aberration range sufficient to extend the effective depth of field (DOF) into the workpiece.

### CROSS-REFERENCE TO RELATED APPLICATION

The present application is a continuation-in-part of U.S. patent application Ser. No. 12/962,050 filed Dec. 7, 2010, which claims the benefit of U.S. Provisional Patent Application Ser. No. 61/267,190 filed Dec. 7, 2009, both of which are incorporated herein by reference.

### TECHNICAL FIELD

The present invention relates to laser machining, and more particularly, laser scribing with extended depth affectation into a workpiece.

### BACKGROUND INFORMATION

Lasers are commonly used to cut or scribe a workpiece such as a substrate or semiconductor wafer. In semiconductor manufacturing, for example, a laser is often used in the process of dicing a semiconductor wafer such that individual devices (or dies) manufactured from the semiconductor wafer are separated from each other. The dies on the wafer are separated by streets and the laser may be used to cut the wafer along the streets. A laser may be used to cut all the way through the wafer, or part way through the wafer with the remaining portion of the wafer separated by breaking the wafer at the point of perforation. When manufacturing light emitting diodes (LEDs), for example, the individual dies on the wafer correspond to the LEDs.

As the sizes of semiconductor devices decrease, the number of these devices that may be manufactured on a single wafer increases. Greater device density per wafer increases the yield, and similarly reduces the cost of manufacturing per device. In order to increase this density, it is desirable to fabricate these devices as close together as possible. Positioning the devices more closely on the semiconductor wafer results in narrower streets between the devices. The laser beam is thus positioned precisely within the narrower streets and should scribe the wafer with minimal or no damage to the devices.

According to one technique, a laser may be focused onto a surface of the substrate or wafer to cause ablation of the material and to effect a partial cut. Laser scribing may be performed on a semiconductor wafer, for example, on the front side of the wafer with the devices formed thereon, referred to as front-side scribing (FSS), or on the back side of the wafer, referred to as back-side scribing (BSS). Although these techniques have been effective, there have also been drawbacks. Both processes often cause significant debris generation and often require coating and rinsing processes to eliminate or reduce debris. Back side scribing often uses a wider kerf and wider heat affected zone (HAZ) resulting in heat generation that may cause epi damage and light loss.

According to another technique often referred to as stealth scribing, a laser may be focused inside of a wafer with a high numerical aperture (NA) lens (e.g., NA>0.8) to cause multiphoton absorption within the material. The high NA lens provides a very short working distance and very small depth of field (DOF). This process also has several drawbacks. In particular, stealth scribing may limit the thickness of the wafer, may be difficult on warped wafers, and may be much slower on thicker wafers because several passes may be required to cause separation. Stealth scribing also provides a relatively large spot size at the surface of the wafer, which may prevent front side scribing in narrow streets between dies or require fewer dies per wafer. Stealth scribing techniques also present problems when machining wafers with DBR or metal reflector films because of the inability to obtain the desired focus inside of the wafer. Stealth scribing also requires expensive lenses and tight focus tolerances and stealth scribing equipment generally has higher equipment costs and annual maintenance costs.

### BRIEF DESCRIPTION OF THE DRAWINGS

These and other features and advantages will be better understood by reading the following detailed description, taken together with the drawings wherein:

FIG. 1 is a schematic view of a laser scribing system providing extended depth affectation into a workpiece, consistent with embodiments of the present disclosure.

FIG. 2 is a schematic view of a focal lens for focusing a laser beam with spherical aberrations outside of a diffraction-limited region, consistent with embodiments of the present disclosure.

FIG. 3A is a schematic view of a lens providing a paraxial focused laser beam without spherical aberrations.

FIG. 3B is a schematic view of a lens overfilled beyond a diffraction-limited region to provide an aberrated, focused laser beam with a longitudinal spherical aberration range sufficient to extend the depth of field into a workpiece with a limited transverse spherical aberration range.

FIG. 3C is a schematic view of a lens overfilled further beyond a diffraction-limited region to provide an aberrated, focused laser beam with a greater longitudinal and transverse spherical aberration range.

FIGS. 4A-4C are schematic views of an aberrated, focused laser beam at different focus offsets relative to a surface of a workpiece.

FIGS. 5A-5D are schematic views of a focused laser beam from a 60 mm focal length triplet lens into 250 micron thick sapphire with different focus offsets and with different amounts of spherical aberrations.

FIGS. 6A-6D are schematic views of a focused laser beam from a 54 mm focal length doublet lens into 250 micron thick sapphire with different focus offsets and with different amounts of spherical aberrations.

FIGS. 7A-7D are schematic views of a focused laser beam from a 25 mm focal length triplet lens into 120 micron thick sapphire with different focus offsets and with different amounts of spherical aberrations.

FIG. 8 is a photograph showing a surface of a sapphire substrate with a series of ablation holes formed by a method consistent with an embodiment of the present disclosure.

FIG. 9 is a photograph showing a side of a sapphire substrate with a series of extended affectations extending from the ablation holes formed by a method consistent with an embodiment of the present disclosure.

FIGS. 10A and 10B are schematic views of a laser machining system with a workpiece positioning stage in an alignment position and laser machining position, respectively, consistent with an embodiment of the present disclosure.

FIG. 11 is a side schematic view of back side scribing with opposite side alignment of a laser beam with streets on a semiconductor wafer, consistent with an embodiment of the present disclosure.

FIGS. 12A and 12B are side schematic views of dual side scribing with opposite side alignment of a laser beam with a shallower back side scribe, consistent with an embodiment of the present disclosure.

FIG. 13 is a schematic view of a laser scribing system for scribing with extended depth affectation and an elongated beam spot, consistent with another embodiment of the present disclosure.

### DETAILED DESCRIPTION

Systems and methods for laser scribing, consistent with embodiments of the present disclosure, provide extended depth affectation into a substrate or workpiece by focusing a laser beam such that the beam passes into the workpiece using a waveguide, self-focusing effect to cause internal crystal damage along a channel extending into the workpiece. Different optical effects may be used to facilitate the waveguide, self-focusing effect, such as multi-photon absorption in the material of the workpiece, transparency of the material of the workpiece, and optical aberrations of the focused laser beam. The laser beam may have a wavelength, pulse duration, and pulse energy, for example, to provide transmission at least partially through the material and multi-photon absorption in the material. An aberrated, focused laser beam may also be used to provide a longitudinal spherical aberration range sufficient to extend the effective depth of field (DOF) into the workpiece.

Laser scribing with extended depth affectation may be used to scribe workpieces such as substrates or semiconductor wafers, for example, to provide die separation. According to one application, the laser machining systems and methods described herein may be used to machine semiconductor wafers to separate the dies forming light emitting diodes (LEDs). Laser scribing with extended depth affectation may be used for back-side scribing and/or front-side scribing of semiconductor wafers of varying thicknesses. Different materials may be scribed with extended depth affectation by selecting laser parameters and optics that result in transmission at least partially through the material and multi-photon absorption in the material. In particular, the methods described herein may be used to scribe sapphire, silicon, glass, and other substrates or materials that are capable of allowing a laser beam to pass at least partially through the material while being absorbed sufficiently to cause crystal damage. Laser scribing with extended depth affectation may also be advantageously used on workpieces with opaque coatings, for example, because an initial ablation may cut through the opaque coating.

As used herein, “machining” refers to any act of using laser energy to alter a workpiece and “scribing” refers to the act of machining a workpiece by scanning the laser across the workpiece. Machining may include, without limitation, ablation of the material at a surface of the workpiece and/or crystal damage of the material inside the workpiece. Scribing may include a series of ablations or crystal-damaged regions and does not require a continuous line of ablation or crystal damage. As used herein, “extended depth affectation” refers to the crystal damage that occurs along a channel extending inside the workpiece as a result of laser energy and photon-material interaction within the workpiece.

Laser scribing with extended depth affectation may ablate an outer portion of the material and then focus the beam internally to cause internal fracturing or crystal damage (i.e., extended depth affectation) resulting in or facilitating scribing or dicing, for example, for wafer die separation. The initial ablation may cause a change in index of refraction, which facilitates the waveguide or self-focusing effect of the laser into the cut to cause a convergence within the material crystal structure, thereby effectively focusing high electric field energy to a point where crystal damage occurs. The laser parameters may be optimized to provide a clean ablation (i.e., with minimal debris) that facilitates the self-focusing effect, as will be described in greater detail below. In other embodiments, laser scribing with extended depth affectation may also be performed without ablating the surface of the workpiece.

The extended depth affectation may be achieved by adjusting the laser parameters (e.g., wavelength, pulse duration, and pulse energy) to provide transmission at least partially through the material and multi-photon absorption sufficient to disturb the crystalline structure of the material. In particular, the laser beam may have a wavelength (e.g., infrared, green or ultraviolet) capable of transmission through the material of the workpiece and may include a pulsed laser beam with ultrashort pulses (e.g., less than 1 ns) or short pulses (e.g., less than 200 ns) providing a peak power that causes the multi-photon absorption. By using a substantially transparent target material and a high energy ultrafast laser, therefore, the balance of the irradiance and extended DOF allows a deep volumetric range of interaction with the target material.

The laser wavelength may be in the infrared (IR) range as well as the first through fifth harmonics and more particularly in a range of about, for example, 1.04-1.06 μm (IR), 514-532 nm (green), 342-355 nm (UV), or 261-266 nm (UV). In sapphire, for example, scribing with extended depth affectation may be achieved with a laser wavelength in the UV range (e.g., 266 nm, 343 nm or 355 nm). In silicon, scribing with extended depth affectation may be achieved with a laser wavelength in the IR range, for example, longer than 1.2 μm (where silicon starts to transmit) and more specifically about 1.5 μm. Laser wavelengths in the visible range may be used to scribe glass with extended depth affectation. Scribing with extended depth affectation, as disclosed herein, may also be used with semiconductor and dielectric materials with a band gap including, without limitation, GaAs and other III-V materials, SiC, Si, GaN, AIN, and diamond by using laser wavelengths that transmit through those materials.

Using a longer wavelength (e.g., as compared to conventional scribing techniques) together with a shorter pulse allows better coupling efficiency and absorption of the laser energy particularly in highly transparent materials such as sapphire. The pulse duration may be shorter than the thermal diffusion timescale causing rapid vaporization of the material, i.e., evaporative ablation with a direct solid to vapor transition. To minimize melting in certain materials, for example, the pulse duration may be sub-picosecond. When machining sapphire, for example, ultrashort pulse durations less than about 10 ps may be used. In other examples, longer pulse durations greater than 1 ns or even greater than 100 ns may also be used (e.g., 150 to 200 ns pulses may be used in silicon).

Ultrafast lasers may be used, for example, to generate ultrashort pulses of picoseconds or femtoseconds. In some embodiments, the ultrafast laser may be capable of producing the raw laser beam at different wavelengths (e.g., about 0.35 μm, 0.5 μm, 1 μm, 1.3 μm, 1.5 μm, 2 μm or any increments therebetween) and at different ultrashort pulse durations (e.g., less than about 10 ps). An example of an ultrafast laser includes one of the TruMicro series 5000 picosecond lasers available from TRUMPF. The laser may also provide a pulse energy in a range of about 1 μJ to 1000 μJ at repetition rates in a range of about 10 to 1000 kHz.

Laser scribing with extended depth affectation generally uses longer working distance optics (e.g., a lower NA lens as compared to the high NA lenses used for stealth scribing). The longer working distance and lower NA optics may include, for example, focal lenses having a NA less than 0.8 and more particularly less than 0.5 or less than 0.4. Laser scribing with extended depth affectation may also introduce spherical aberrations with a longitudinal spherical aberration range sufficient to extend the effective DOF into a workpiece. Longer working distance, lower NA lenses generally have a longer DOF as compared to higher NA lenses. Using a lens that introduces spherical aberrations may further extend the effective DOF such that the waveguide, self-focusing effect adds energy over an extended zone into the workpiece.

As discussed in greater detail below, the depth of extended depth affectation may be controlled by adjusting the laser parameters (e.g., wavelength, pulse duration, and pulse energy), processing parameters (e.g., pulse spacing), and optics (e.g, operating NA and depth of focus).

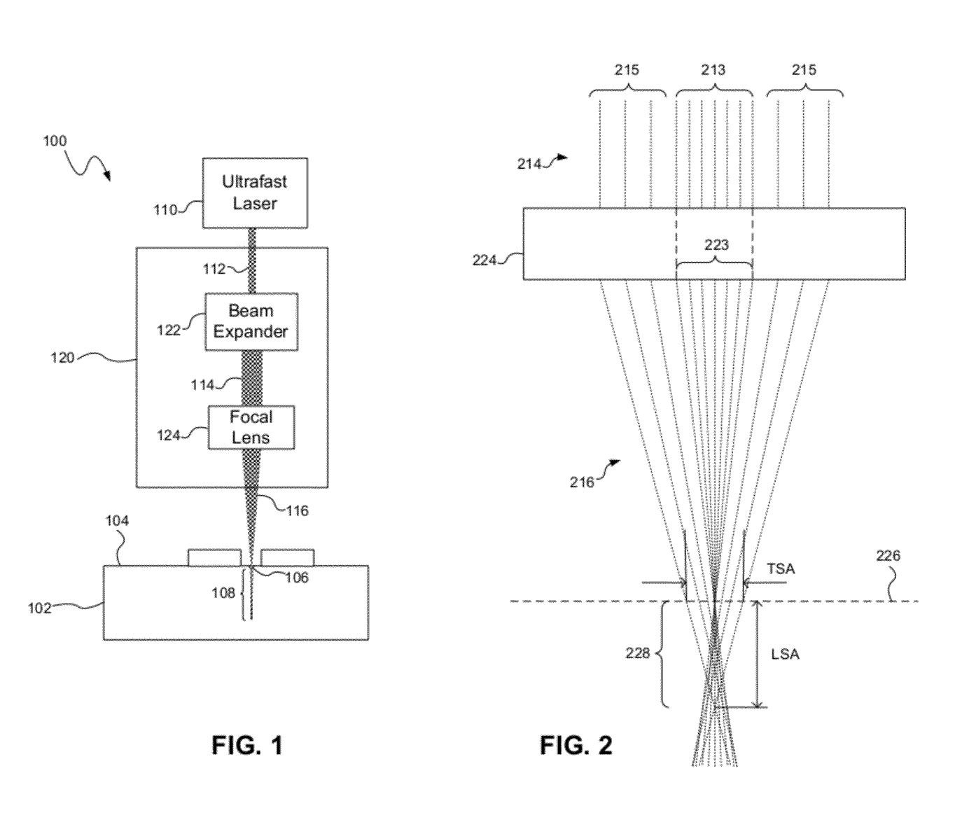

Referring to FIG. 1, an embodiment of a laser machining system 100 for laser scribing with extended depth affectation may be used to scribe a workpiece 102, such as a sapphire substrate of a semiconductor wafer. This embodiment of the laser machining system 100 includes a laser 110 for generating a raw laser beam and a beam delivery system 120 for focusing the laser beam and directing the focused laser beam to a surface 104 of the workpiece 102. The beam delivery system 120 includes a beam expander 122 for expanding a raw laser beam 112 from the laser 110 to form an expanded beam 114 and a focusing lens 124 for focusing the expanded beam 114 to provide a focused laser beam 116. The beam delivery system 120 may also include an auto focus system (not shown), although it may not be required.

In the illustrated embodiment, the laser machining system 100 focuses the expanded laser beam 114 such that an energy density of the focused laser beam 116 is sufficient to ablate the surface 104 of the workpiece 102 in an ablation zone 106 and such that the beam passes through the ablation zone 106 and into the workpiece 102 using the waveguide self-focusing effect. The waveguide self-focusing effect thus directs the focused laser beam 116 from the ablation zone 106 to an internal location 108 extending within the workpiece 102 where crystal damage is caused due to shock, electric fields and/or pressure. Each pulse of the focused laser beam 116 forms a beam spot on the workpiece 102 and extends into the workpiece 102 using the waveguide, self-focusing effect to provide high energy over an extended depth and cause the crystal damage along the channel at the internal location 108. Although a single pulse of the focused laser beam 116 may be sufficient at each location, a multiple pulse process may be used with subsequent pulses providing deeper or stronger material fracturing.

The focused laser beam 116 may be scanned across the workpiece 102 such that a series of ablation zones 106 and crystal-damaged internal locations 108 (i.e., extended affectations) are formed along a scribe line by a series of laser pulses. The laser beam 116 may be scanned using a single pass or multiple passes, for example, to achieve a variety of depths and spacings. The workpiece 102 may be moved relative to the focused laser beam 116, for example, to form the series of ablation zones 106 and crystal-damaged internal locations 108. The ablation zones 106 and crystal-damaged internal locations 108 may then facilitate separation of the workpiece 102 along the scribe line. Although the illustrated embodiment shows front side scribing on a semiconductor wafer with LED dies, the laser machining system 100 may also be used for back side or dual side scribing, as will be described in greater detail below.

Depending upon the type of material, the laser 110 may be capable of emitting short pulses (e.g., less than about 200 ns) or ultrashort pulses (e.g., less than about 1 ns) at a wavelength capable of passing at least partially through the material of the workpiece 102. According to one example for scribing sapphire with extended depth affectation, the laser 110 is an ultrafast laser that emits a raw laser beam at a wavelength in the UV range (e.g., about 266 nm, 343 nm or 355 nm) with a pulse duration of less than about 10 ps and a pulse energy of about 600 μJ. Such a laser provides a wavelength capable of passing through sapphire and a sufficiently high peak power to damage the crystal at the internal location within the sapphire. The laser 110 may be operated at a repetition rate to achieve a desired scribe at a particular scan speed. According to one example of machining sapphire, the UV laser with a pulse energy of about 600 μJ may be operated with a repetition rate of about 33.3 kHz and a scan speed in a range of about 70 mm/s to 90 mm/s. In another example, the repetition rate may be about 100 kHz with a scan speed of about 100 mm/s to 300 mm/s. In other embodiments, a lower power laser (e.g., about 8 W) may be used with a reduced pulse energy (e.g., about 40 μJ) and a higher repetition rate (e.g., about 200 kHz).

The beam expander 122 may be a 2× expanding telescope and the focusing lens 124 may be a 60 mm triplet to achieve an effective focusability with a focal depth of about 400 μm and a desired kerf width of about 3 μm. The beam expander 122 may be a beam expanding telescope, for example, including a combined uncoated negative lens (e.g., f=−100 mm) and a positive lens (e.g., f=200 mm). The focusing lens 124 may have a NA less than 0.8 and more particularly less than 0.5 or less than 0.4, which provides a longer working distance and a longer DOF. The focusing lens 124 may also introduce spherical aberrations to provide an aberrated, focused laser beam 116 with a longitudinal spherical aberration range sufficient to extend the effective DOF further into the workpiece 102, as described in greater detail below.

The combination of the focused laser beam with the ultrashort or short pulses allows an increased focusability (with lower NA optics) to provide the crystal damage at the internal location 108 of the workpiece 102 while minimizing the volume of removed material (e.g., the debris) on the surface 104 of the workpiece. The laser 110 and the beam delivery system 120 may be configured with laser machining parameters, such as wavelength, pulse duration, pulse energy, peak power, repetition rate, scan speed, and beam length and width, which achieve the surface ablation and self-focusing effect for the material to be scribed and the desired kerf widths.

As shown in greater detail in FIG. 2, the extended depth affectation may be facilitated by extending the effective DOF of an aberrated, focused laser beam 216 using lens aberrations of a focal lens 224. Lens aberrations are deviations of light rays through a lens from an ideal path predicted by paraxial optics. Spherical aberrations, in particular, result from deviations of light rays passing through a lens farther from an optical axis of the lens.

In this embodiment, a portion of the focal lens 224 generally includes a diffraction-limited region 223 that provides diffraction-limited performance that is essentially free of aberrations (i.e., the affect on performance due to diffraction exceeds the affect on performance due to aberrations). Light rays 213 of a laser beam 214 illuminating the lens 224 within the diffraction-limited region 223 are focused at the paraxial focal plane 226 producing a high resolution focused beam spot within this region of the focused laser beam 216. Outside of the diffraction-limited region 223, the focal lens 224 introduces spherical aberrations into the aberrated, focused laser beam 216. Light rays 215 illuminating the lens 224 outside of the diffraction-limited region 223 deviate from the paraxial focal point and are focused (i.e., cross the optical axis of the lens 224) at extended focal points after the paraxial focal plane 226. The spherical aberrations thus effectively extend the focal point of the aberrated, focused laser beam 216 continuously from the paraxial focal point.

The distance that the focal points of the aberrated rays 215 extend along the optical axis of the lens 224 beyond the paraxial focal plane 226 is the longitudinal spherical aberration (LSA) range and the distance that the aberrated rays 215 extend along the paraxial focal plane 226 is the transverse spherical aberration (TSA) range. The LSA range extends the effective DOF 228 of the focused laser beam 216 beyond the paraxial focal plane 226 and facilitates the extended depth affectation into a workpiece, as described in greater detail below.

Embodiments of the present disclosure thus use the imperfections of a focal lens in a way that is contrary to conventional wisdom. In lens systems used for laser scribing, avoiding or correcting lens aberrations is often desirable to provide a well-focused beam spot. According to embodiments of the present disclosure, however, lens aberrations are used intentionally to create an optical effect that extends DOF to scribe a workpiece with extended depth affectation. Moreover, the lenses used for laser scribing with extended depth affectation, as described herein, may be less expensive than the high NA lenses required for stealth scribing.

The focal lens 224 may include multi-element lenses, such as a lens doublet or lens triplet, which corrects aberrations within the diffraction-limited region 223 but not across the full aperture of the lens 224. The focal lens 224 may also provide a relatively long working distance and low NA less than about 0.8 and more particularly less than about 0.5 or less than about 0.4. Different substrate materials and thicknesses may have a different optimum parameter combination for scribing with extended depth affectation including wavelength, pulse duration, operating NA, longitudinal spherical aberration range, and defocus. Thus, the exact optical parameters of the lens will depend on the type of material to be scribed.

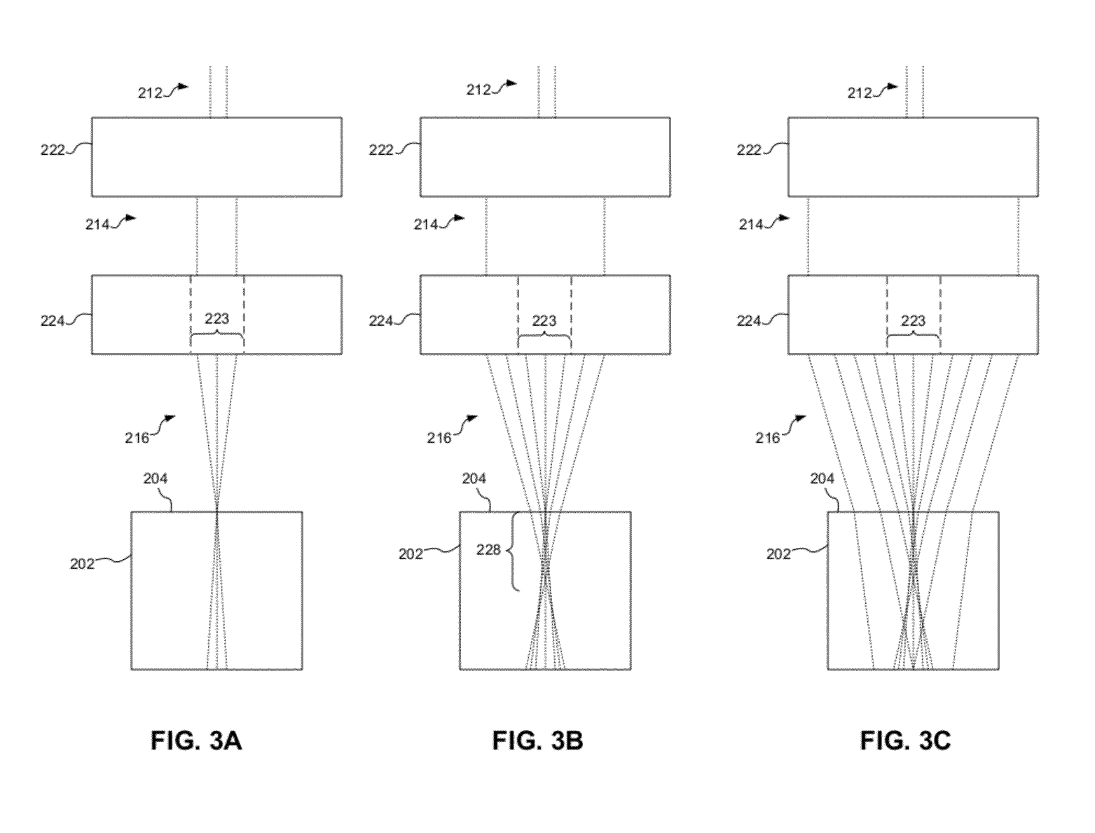

As shown in FIGS. 3A-3C, the focal lens 224 may be designed and/or illuminated to introduce a longitudinal spherical aberration range sufficient to extend the effective DOF with a limited transverse spherical aberration range. For example, the working or operating NA (or F#) of the lens 224 may be selected to achieve the longitudinal spherical aberration range that will provide the desired extended affectation within a workpiece 202 while limiting the transverse spherical aberration range such that the focused beam spot size on a surface 204 of the workpiece 202 is not too large. The desired beam spot size on the surface 204 of the workpiece depends upon the particular application and may be less than about 20 μm for scribing semiconductor wafers and die separation.

In this embodiment, the working or operating NA of the lens 224 may be adjusted by expanding a raw laser beam 212 using a beam expander 222 to produce an expanded laser beam 214 that illuminates a variable portion of the clear aperture of the lens 224. When the expanded laser beam 214 only illuminates the aperture of the lens 224 within the diffraction-limited region 223, as shown in FIG. 3A, the focused beam 216 includes only paraxial rays that focus to the paraxial focal plane, which is shown on the surface 204 of the workpiece 202. This does not provided a longitudinal spherical aberration range that extends the effective DOF into the workpiece 202 to provide extended depth affectations.

When the expanded laser beam 214 illuminates the aperture of the lens 224 just beyond the diffraction-limited region 223, as shown in FIG. 3B, the focused beam 216 also includes aberrated rays that focus beyond the paraxial focal plane with a longitudinal spherical aberration range extending the DOF 228 into the workpiece 202. Because longitudinal spherical aberration dominates when the lens is operating near but not quite diffraction limited, the transverse spherical aberration range of the aberrated rays of the focused beam 216 may be limited. Thus, the longitudinal spherical aberration range extends the DOF while still keeping the transverse spot size under control.

When the expanded laser beam 214 illuminates the full aperture of the lens 224, as shown in FIG. 3C, the focused beam 216 includes aberrated rays that further extend the transverse spherical aberration range and further increases the beam spot size on the surface 204 of the workpiece 202. In this example, the increased transverse spherical aberration range may negate the effects of the extended DOF provided by the longitudinal spherical aberration.

Accordingly, the lens 224 may be illuminated with an operating NA such that the longitudinal spherical aberration range sufficiently extends the DOF into the workpiece to cause the desired extended depth affectation but with a limited transverse spherical aberration range. The beam size may be gradually increased at the lens 224 (e.g., increasing the operating NA) until the optimum size is found to generate the extended depth affectation inside of the material of the workpiece 202. Limiting the transverse spherical aberration range enables smaller beam spot sizes at the surface of the workpiece, smaller laser zones, and smaller ablation zones while still allowing a longitudinal spherical aberration range sufficient to extend the effective DOF. In one embodiment, the transverse spherical aberration range may be limited sufficiently to result in a laser zone of less than about 20 μm and more specifically 10-20 μm and an ablation zone less than about 10 μm and more specifically about 5 μm.

For a given material, wavelength and pulse duration, the optimum NA and pulse energy will depend on the material thickness. For thin materials (e.g., 90 μm-110 μm sapphire), a desired extended depth affectation depth may be achieved with an operating NA of about 0.15 to 0.2 and a pulse energy in a range of about 10 to 50 μJ. Using a 25 mm focal length triplet having an 18 mm clear aperture, for example, a suitable spot size with a longitudinal spherical aberration range sufficient to achieve extended depth affectation in a material thickness of 90 μm-110 μm may be achieved by illuminating about 8 mm of the 18 mm aperture of the 25 mm triplet. For machining thin sapphire with a picosecond 355 nm laser, for example, a 25 mm focal length triplet lens may be operated at about 0.16 NA to achieve extended depth affectation to a desired depth. In this example, the longitudinal aberration coefficient is about 0.0133 and the transverse aberration coefficient is about 0.0024 according to a Zemax analysis.

For thicker materials (e.g., 250 μm-500 μm sapphire), a desired extended depth affectation matching the thicker material may be achieved with a lower operating NA of about 0.05 to 0.1 and a higher pulse energy in a range of about 30 to 70 μJ. For machining thick sapphire with a picosecond 355 nm laser, a 60 mm focal length triplet may be operated at about 0.07 NA to achieve extended depth affectation to a desired depth. The pulse energy may be higher or lower depending upon the pulse spacing to achieve a desired depth. For example, a lower pulse energy may be used with a shorter pulse spacing and a higher pulse energy may be needed with a longer pulse spacing.

Other techniques may also be used to reduce or eliminate excessive transverse spherical aberrations. For example, an aperture may be placed ahead of the lens 224 to limit the maximum beam diameter 214 into the lens 224, thereby limiting the maximum NA.

As mentioned above, different materials may be scribed with extended depth affectation at various depths using different laser parameters and optics. In sapphire, for example, a 25 mm focal length triplet lens with an ultrafast UV laser may achieve over 100 micron depth extended depth affectation. In silicon with a longer lens and IR laser with higher power, a further depth of extended depth affectation may be achieved (e.g., 300 microns).

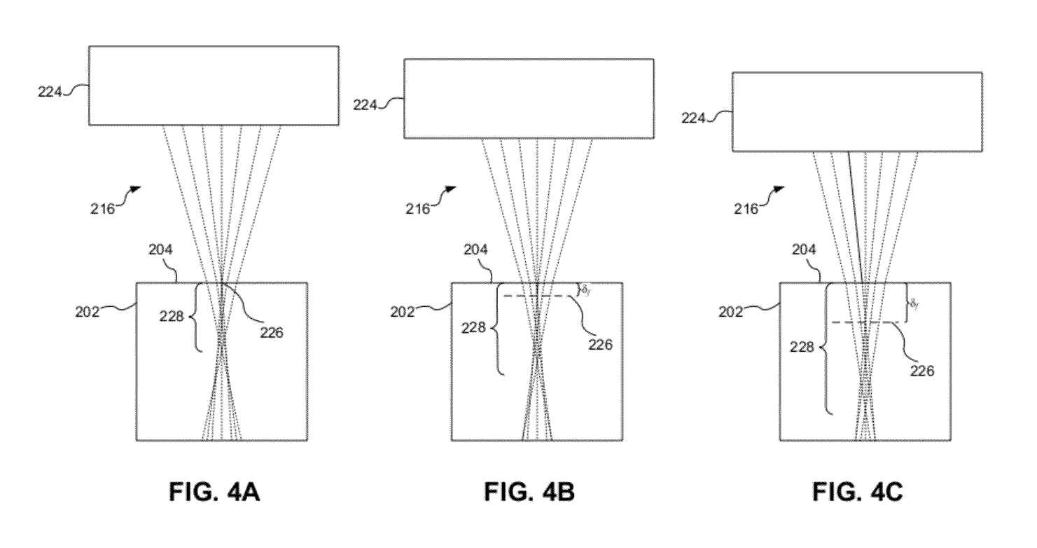

As shown in FIGS. 4A-4C, a focus offset of an aberrated focused laser beam 216 relative to a surface 204 of a workpiece 202 may also be selected or adjusted, for example, to vary an extended DOF 228 into the workpiece 202 and/or beam spot size and energy density at the surface 204 of the workpiece 202. The focus offset may be selected, for example, to optimize a depth of the extended depth affectation into the workpiece 202 and to minimize surface damage or debris. The extended depth affectation may thus have an adjustable depth control by adjusting the focus offset as well as other laser and optics parameters, such as laser pulse energy. The focus offset may be adjusted, for example, by adjusting a position of the focal lens 224 relative to the workpiece 202.

FIG. 4A shows the aberrated focused laser beam 216 with paraxial rays focused at a surface 204 of the workpiece 202 without a focus offset, i.e., the paraxial focal plane 226 substantially coincides with the surface 204. FIG. 4B shows the aberrated focused laser beam 216 with paraxial rays focused below the surface 204 of the workpiece 202 with a focus offset δ_{f} between the surface 204 and the paraxial focal plane 226, thereby extending the effective DOF 228 further into the workpiece 202. FIG. 4C shows the aberrated focused laser beam 216 with paraxial rays focused below the surface 204 of the workpiece 202 with a greater focus offset δ_{f} between the surface 204 and the paraxial focal plane 226, thereby extending the effective DOF 228 even further into the workpiece 202.

The optimum focus offset may vary depending on the substrate material (e.g., refractive index at the scribing wavelength) and the substrate thickness and on the operating NA of the lens and resulting aberration coefficients for the conditions under which the lens is operating. The focus offset may also depend on the type of process (e.g., front-side or back-side). For scribing a 90 μm-110 μm sapphire substrate using a 25 mm triplet at 0.16 NA with a 10 ps 355 nm laser, for example, an optimum focus offset may be in the 20 μm to 40 μm range for backside scribing.

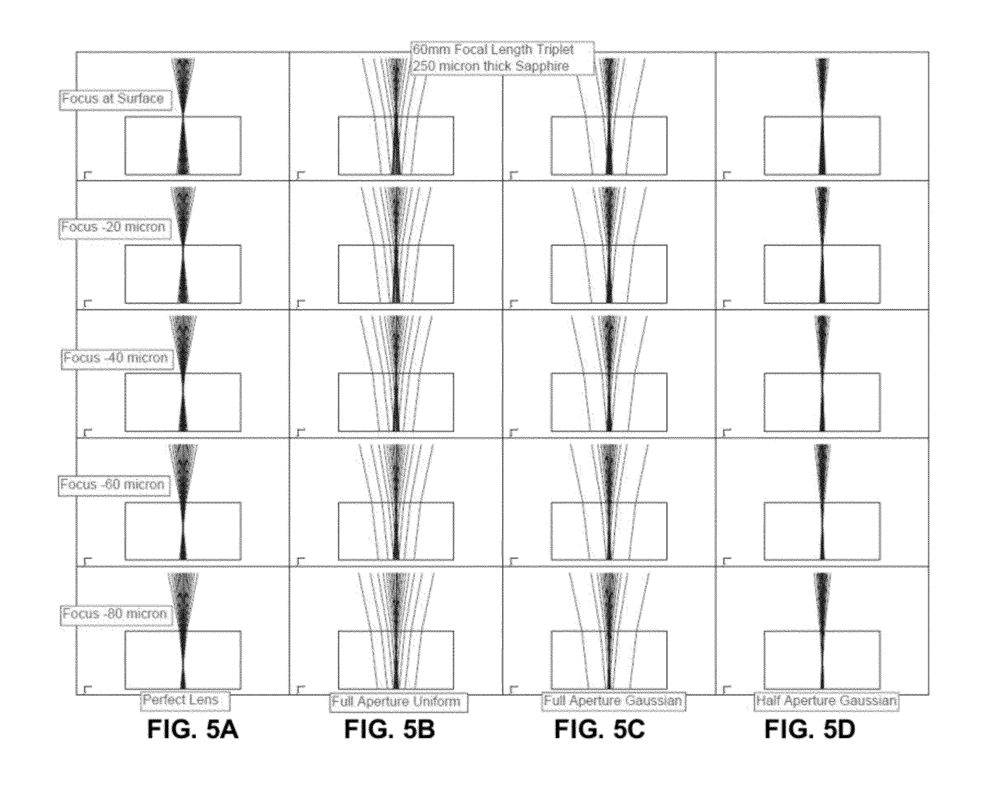

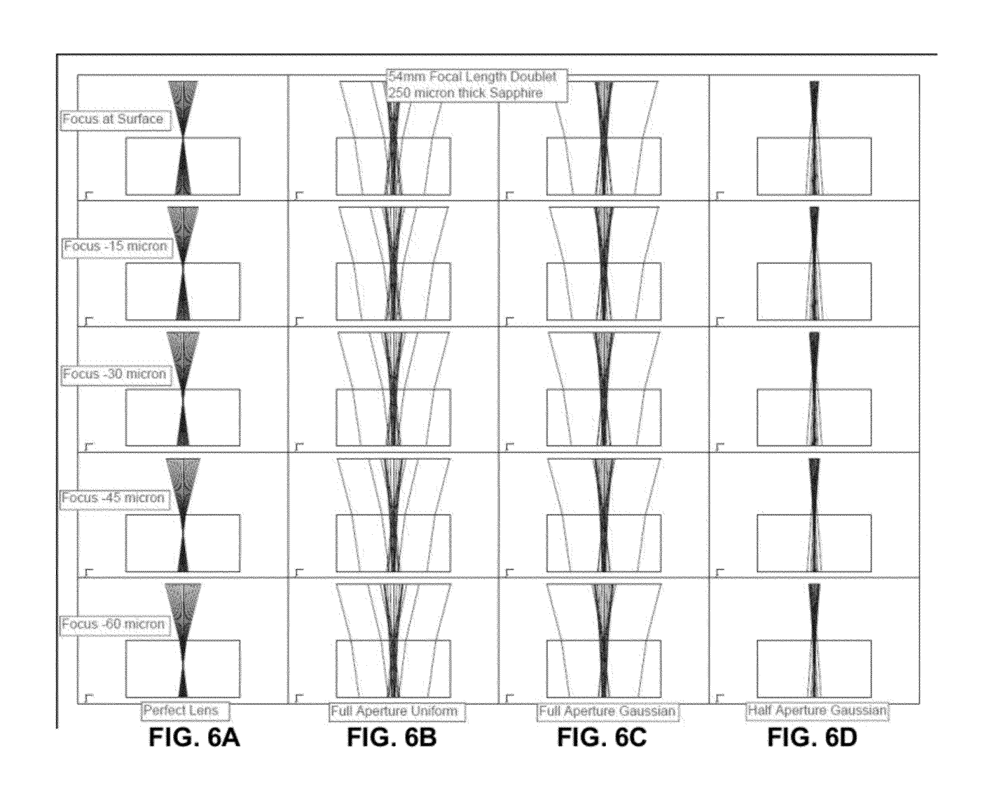

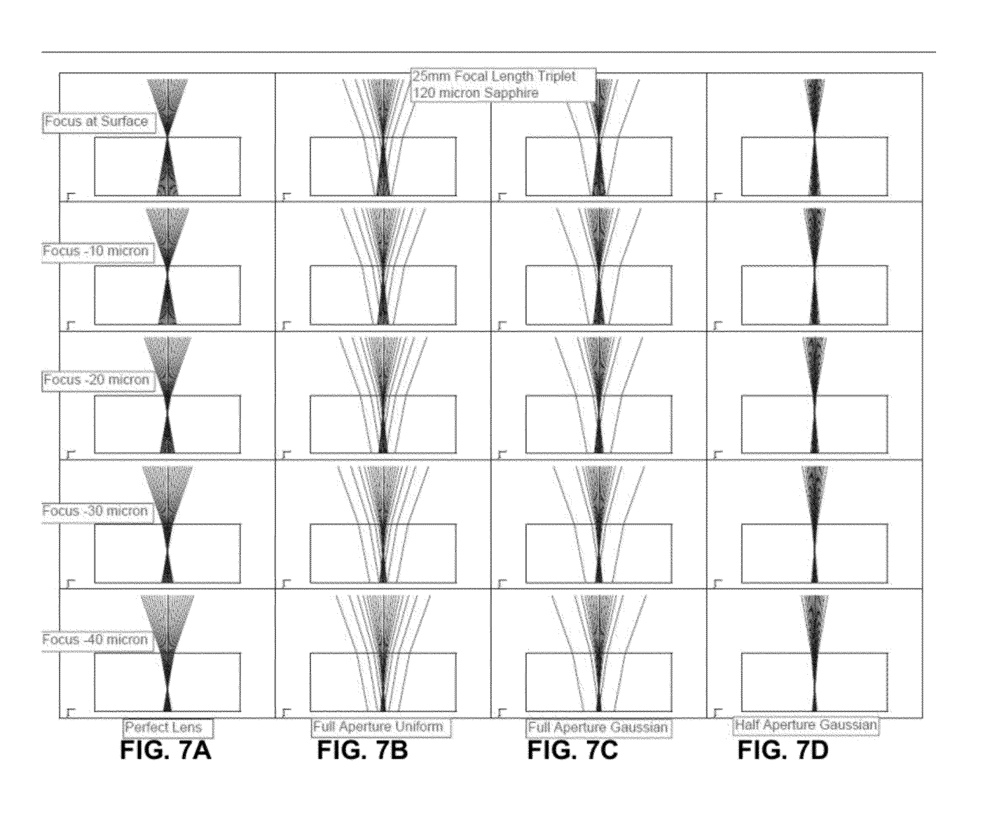

FIGS. 5A-5D show the ray geometry of a focused laser beam using a 60 mm focal length triplet lens in 250 micron thick sapphire with different amounts of spherical aberration and different focus offsets in 20 micron increments. FIGS. 6A-6D show the ray geometry of a focused laser beam using a 54 mm focal length doublet lens in 250 micron thick sapphire with different amounts of spherical aberration and different focus offsets in 15 micron increments. FIGS. 7A-7D show the ray geometry of a focused laser beam using a 25 mm focal length triplet lens in 120 micron thick sapphire with different amounts of spherical aberration and different focus offsets in 10 micron increments.

A perfect lens would provide the paraxial ray geometry shown in FIGS. 5A, 6A and 7A. A real lens with a diffraction-limited region, consistent with embodiments described herein, introduces spherical aberrations as shown in FIGS. 5B-5D, 6B-6D, and 7B-7D. FIGS. 5B, 6B, and 7B illustrate the ray geometry of aberrated rays provided by a real lens illuminated at full aperture with a uniform laser beam. FIGS. 5C, 6C, and 7C illustrate the ray geometry of aberrated rays provided by a real lens illuminated at full aperture with a Gaussian laser beam. FIGS. 5D, 6D and 7C illustrate the ray geometry of aberrated rays provided by a real lens illuminated at partial aperture with a Gaussian laser beam.

In the illustrated examples, when the aperture is too large (FIGS. 5B, 5C, 6B, 6C, 7B, and 7C), the transverse spherical aberration range is too large and the aberrated, focused beam blows up. At the partial aperture (FIGS. 5D, 6D, and 7D), the aberrated, focused beam has a relatively tight focus with an extended effective DOF as compared to the paraxial or perfect lens (FIGS. 5A, 6A, and 7A). According to one example, therefore, a desired lens and NA combination for a particular substrate material and thickness results in nearly diffraction-limited transverse spot size but with a longitudinal spherical aberration range sufficient to extend the effective DOF to match material thickness.

Although specific examples are describe with lenses having a focal length of 25 mm, 54 mm, and 60 mm, lenses with other focal lengths may also be used to provide the desired NA and spherical aberrations. For example, the focal length may be less than 25 mm or greater than 60 mm.

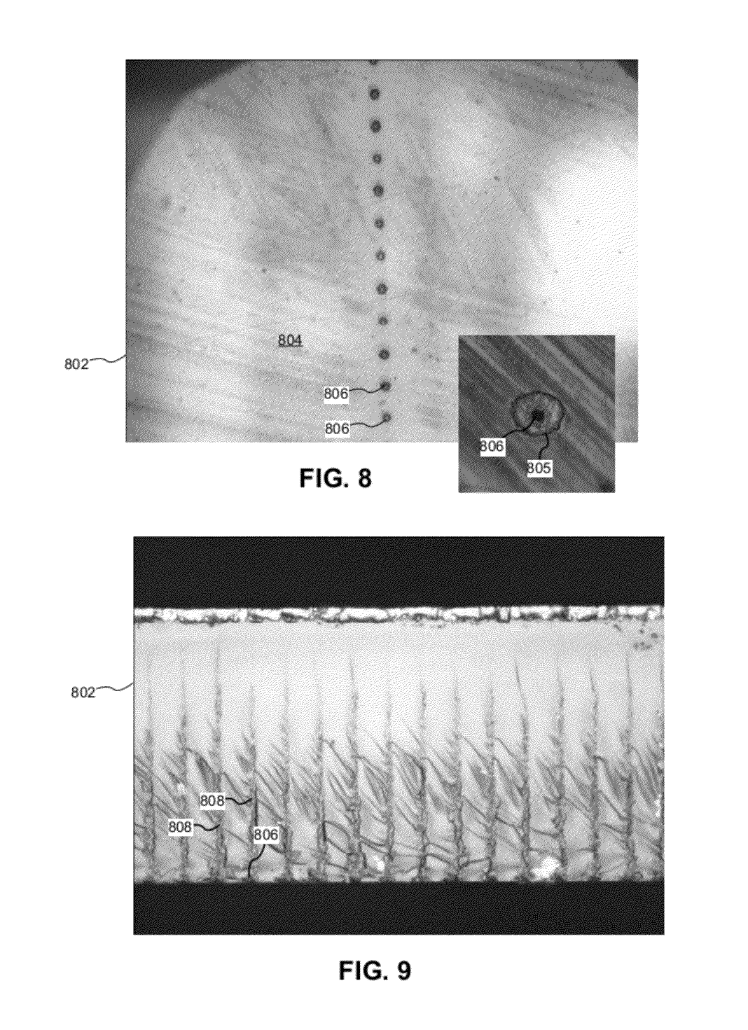

FIGS. 8 and 9 show photographs of a sapphire substrate 802 scribed by a series of laser pulses with extended depth affectation into the sapphire substrate 802. Each laser pulse forms an ablation zone or hole 806 where the laser enters the sapphire substrate 802 with a laser zone 805 around the ablation hole 806 and an extended depth affectation channel 808 extending from the ablation hole 806 into the material of the substrate 802. The substrate 802 may thus be separated along the scribe line formed by the series of ablation holes 806 and extended depth affectation channels 808.

In the illustrated embodiment, the ablation holes 806 are about 5 microns wide with a 20 micron laser zone 805 and spacing of about 15 microns, and the extended depth affectation channels 808 extend about 100 microns into the 150 micron thick sapphire substrate 802. The scribing with extended depth affectation, consistent with the embodiments described herein, thus allows scribe sites of less than 20 microns. The smaller scribe sites (e.g., as compared to stealth scribing) thus allows narrower streets (e.g., <25 microns) and closer die spacing without significant damage and debris when scribing semiconductor wafers with LEDs. The depth of the extended depth affectation channels 808 improves breaking along the scribe line even when the spacing between the scribe sites is larger. The depth of the extended depth affectation channels 808 also allow scribing of thicker substrates without multiple passes of the laser at different focal points within the substrate, for example, as required by stealth scribing. The spacing of the scribe sites allows faster scribing using a single pulse per scribe site, for example, as compared to overlapping pulses.

Other scribe site sizes, depths, and spacings may be achieved with different laser parameters, for example, by controlling pulse spacing and depth. Although a single pulse per site is possible, multiple pulses per scribe site may also be used to control depth, for example, by using multiple passes of the laser. Although the illustrated embodiment shows a spacing of about 15 microns and a depth of about 100 microns, the spacing may be controlled from overlapping to 20 microns or greater and the depth may be controlled from less than 100 microns to greater than 200 microns.

In other variations, different depths may be used for different pulses within a pulse train. A pulse train may include, for example, a more frequent series of shallower pulses (e.g., 10 to 20 micron depth separated by 5 to 10 microns) with a deeper pulse (e.g., 50 to 100 microns) spaced less frequently (e.g., every 15 to 50 microns). In other words, a series of deeper pulses may be spaced at longer distances with shallower pulses in between the deeper pulses to increase the breaking properties. By improving breaking properties and breaking yields, scribing with extended depth affectation and controllable depth and spacing may thus be particularly advantageous when producing LEDs where the effect of light propagation from the LED is more to the bottom or middle of the sapphire sidewall. Closer and deeper spacings may be used in cases where light loss is less of a concern, such as in silicon wafers.

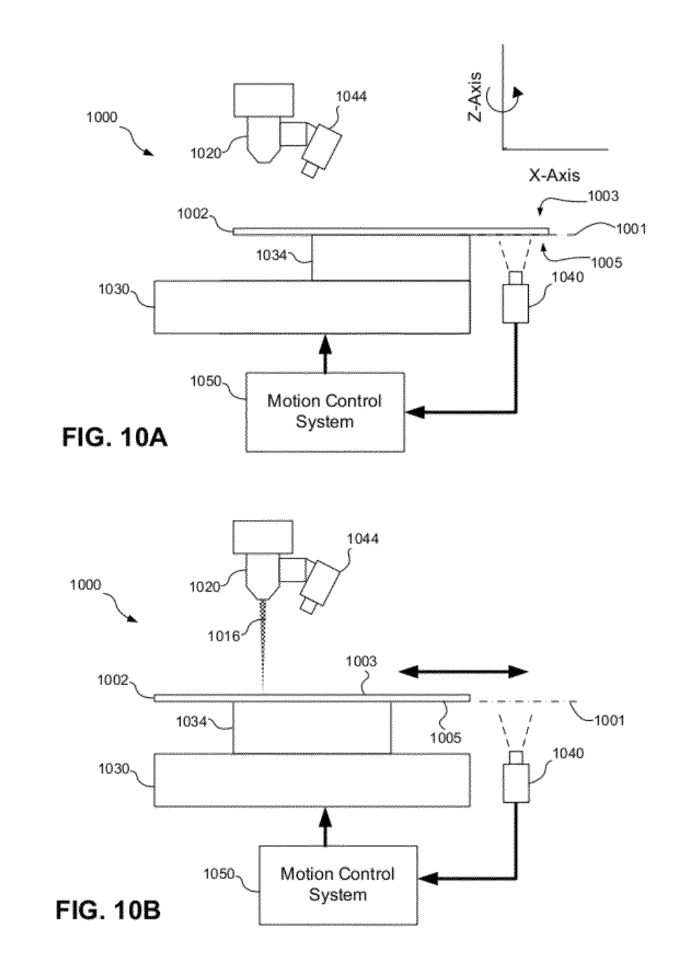

Referring to FIGS. 10A and 10B, a laser machining system 1000, consistent with another embodiment, includes an air bearing X-Y positioning stage 1030 that supports and positions a workpiece 1002 for scribing with extended depth affectation. The laser machining system 1000 includes a laser beam delivery system 1020 mounted on one side (e.g., a top or front side) and an opposite side camera 1040 mounted on an opposite side (e.g., a bottom or back side). At least a workpiece supporting portion 1034 of the positioning stage 1030 is configured to slide between an alignment position (FIG. 10A) with the opposite side camera 1040 facing the workpiece 1002 and a machining position (FIG. 10B) with the laser beam delivery system 1020 facing the workpiece 1002. The laser beam delivery system 1020 is above a plane 1001 of a workpiece support surface on the supporting portion 1034 and the opposite side camera 1040 is below the plane 1001 of the workpiece support surface on the supporting portion 1034. One example of the air bearing X-Y positioning stage is described in greater detail in U.S. patent application Ser. No. 12/962,050, which is fully incorporated herein by reference.

In the alignment position, the opposite side camera 1040 images a feature on a side 1005 of the workpiece 1002 facing the camera 1040 and generates image data representing that feature. The image data generated by the opposite side camera 1040 may be used to position the workpiece 1002 such that the laser beam delivery system 1020 is aligned relative to the feature imaged on the opposite side 1005 of the workpiece 1002, for example, using machine vision systems and alignment techniques known to those skilled in the art. In the machining position, the laser beam delivery system 1020 directs a focused laser beam 1016 (e.g., an aberrated, focused laser beam with an extended DOF) toward a side 1003 of the workpiece 1002 facing the beam delivery system 1020 and machines the workpiece 1002 using scribing with extended depth affectation as described above.

The laser machining system 1000 also includes a motion control system 1050 that controls the motion of the positioning stage 1030 during alignment and/or machining of the workpiece 1002. The motion control system 1050 may generate alignment data from the image data generated by the opposite side camera 1040 and controls the motion of the positioning stage 1030 in response to the alignment data.

The laser beam delivery system 1020 may include lenses and other optical elements that modify and focus a raw laser beam generated by a laser, for example, as described above. The laser (not shown) may be located, for example, on a platform of the laser machining system 1000 and the raw laser beam generated by the laser may be directed into the laser beam delivery system 1020.

The laser machining system 1000 may also include a front side camera 1044 to image the workpiece 1002 on the front side. The front side camera 1044 may be mounted to the beam delivery system 1020 or other suitable location. The front side camera 1044 may similarly be coupled to the motion control system 1050 such that the motion control system 1050 may use the image data generated from the front side camera 1044 to provide alignment. The laser machining system 1000 may thus allow alignment from the back side opposite the laser beam or from the front side or same side as the laser beam. The opposite side camera 1040 and front side camera 1044 may be high resolution cameras known to those skilled in the art for alignment of semiconductor wafers in laser machining applications.

The laser machining system 1000 may thus be used to align the beam delivery system 1020 and focused laser beam 1016 with streets between dies on a semiconductor wafer. When properly aligned, the X-Y positioning stage 1030 may move the workpiece 1002 to scan the laser beam across the workpiece 1002 such that a series of pulses scribe the workpiece 1002, for example, along a street between dies on a wafer or along a side of the wafer opposite the street. The X-Y positioning stage 1030 may then move the workpiece to index to another street for scribing. The alignment process may be repeated as need for scribing within or along other streets.

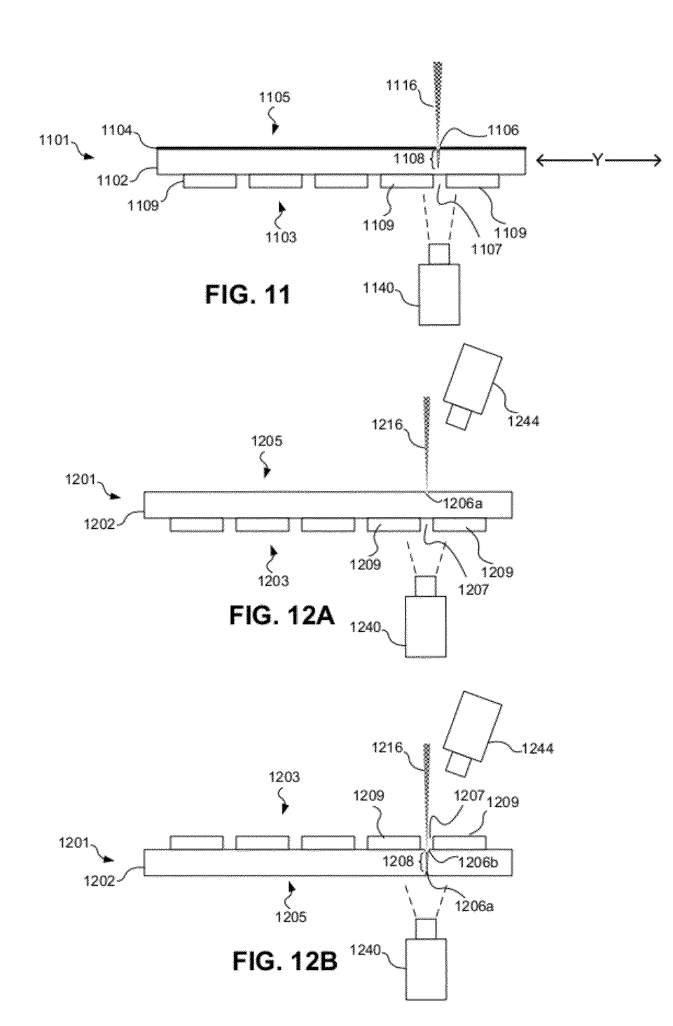

Referring to FIG. 11, opposite side alignment may be used to facilitate back side scribing of a semiconductor wafer 1101 to separate a plurality of semiconductor dies (e.g., LEDs). The semiconductor wafer 1101 may include a substrate 1102 (e.g., sapphire) and one or more layers of semiconductor material (e.g., GaN) formed into sections 1109 separated by streets 1107. The side of the semiconductor wafer 1101 with the sections 1109 is referred to as the front side 1103 and the opposite side is referred to as the back side 1105. The substrate 1102 may also have one or more layers 1104 (e.g., metal) on the back side 1105 opposite the sections 1109.

A laser machining system, such as those described above, may be used to scribe the semiconductor wafer 1101 along the streets 1107 between the die sections 1109 to separate the semiconductor wafer 1101 into individual dies. The semiconductor wafer 1101 is thus aligned such that a laser beam 1116 is directed at the semiconductor wafer 1101 between the streets 1107, thereby providing registration of the die sections 1109 with the laser beam 1116. As described above, the semiconductor wafer 1101 may be scribed by forming a series of ablation zones 1106 with extended depth affectation 1108. Scribing with extended depth affectation and ablation is particularly advantageous when the layer 1104 is opaque because the ablation removes the layer 1104 and allows the laser beam 1116 to pass into the substrate 1102. In another variation, a first pass of a laser may be used to ablate and remove the layer 1104 and a second pass of a laser provides the extended depth affectation.

When laser machining the back side 1105 of the semiconductor wafer 1101, the semiconductor wafer 1101 may be positioned such that the die sections 1109 on the front side 1103 of the wafer 1101 face the opposite side camera 1140. The opposite side camera 1140 may thus be used to view the streets 1107 between the sections 1109 and to provide alignment of the streets 1107 relative to a location of the laser beam 1116. Alignment using the opposite side camera 1140 is particularly advantageous when the back side layer(s) 1104 are opaque (e.g., metal) and prevent alignment from the machining side. To provide such alignment, the wafer 1101 is positioned along the Y axis relative to the laser beam delivery system (not shown) such that the scribe formed by the laser beam 1116 on the back side 1105 of the wafer 1101 is located within the width of the street 1107 on the front side 1103.

Referring to FIGS. 12A and 12B, opposite side alignment may be used to facilitate dual side scribing. In general, dual side scribing involves forming relatively shallow scribes on both sides of a workpiece with one of the scribes substantially aligned relative to the other of the scribes. Forming shallow scribes minimizes or avoids damage that may be caused by deeper scribes while having scribes on both sides may improve breaking yields because cracks are more likely to propagate between the scribes.

According to one exemplary method, a semiconductor wafer 1201 may first be positioned (e.g., on the workpiece support) with a back side 1205 facing a laser beam delivery system (not shown) and a front side 1203 facing an opposite side camera 1240 (FIG. 4A). With the wafer 1201 in this position, the opposite side camera 1240 may be used to image one of the streets 1207 between the sections 1209 so that the wafer 1201 can be positioned such that the laser beam 1216 on the back side 1205 is aligned with the street 1207 on the front side 1203. When the semiconductor wafer 1201 has been aligned, the laser beam 1216 may be used to scribe the back side 1205 forming a relatively shallow back side scribe 1206a (e.g., 20 microns or less).

The semiconductor wafer 1201 may then be flipped such that the front side 1203 faces the laser beam delivery system and the back side 1205 faces the opposite side camera 1240 (FIG. 4B). With the wafer 1201 in this position, the opposite side camera 1240 may be used to image the back side scribe 1206a so that the wafer 1201 can be positioned such that the laser beam 1216 is aligned with the back side scribe 1206a. When the semiconductor wafer 1201 has been aligned, the laser beam 1216 may be used to scribe the front side 1203 in the street 1207 between the sections 1209 to form a front side scribe 1206b substantially aligned with the back side scribe 1206a. The front side scribe 1206b may include a series of ablation zones with extended depth affectation 1208, for example, as described above. In addition to or instead of the opposite side camera 1240 providing alignment, a machining side camera 1244 may image the street 1207 to provide alignment of the laser beam 1216 with the street 1207.

The wafer 1201 may then be separated into individual dies by breaking along the locations of the scribes 1206a, 1206b such that cracks propagate between the scribes 1206a, 1206b facilitated by the extended depth affectation 1208. When the sections 1209 correspond to LEDs, for example, the front side scribe 1206b better defines the edge of the LED such that the LED is more uniform and breakage yields are improved (e.g., as compared to shallow scribes on one side only). Furthermore, the LED light and electrical properties are less likely to be adversely affected because the scribes 1206a, 1206b are not deep enough to cause significant thermal damage.

According to another alternative method, the front side scribe 1206b with extended depth affectation 1208 may be formed first on the front side 1203 (e.g., using the machining side camera 1244 to provide alignment relative to the streets 1207). The wafer 1201 may then be flipped and the back side scribe 1206a may be formed on the back side 1205 (e.g., using the opposite side camera 1240 to provide alignment relative to the front side scribe 1206b and/or streets 1207). One of the scribes may be shallower than the other scribe. For example, the shallower scribe (e.g., 20 microns or less) may be formed first with the second, less shallow scribe being aligned with the shallower scribe. According to another variation of a dual side scribing method, the back side scribe 1206a may be formed with the extended depth affectation 1208.

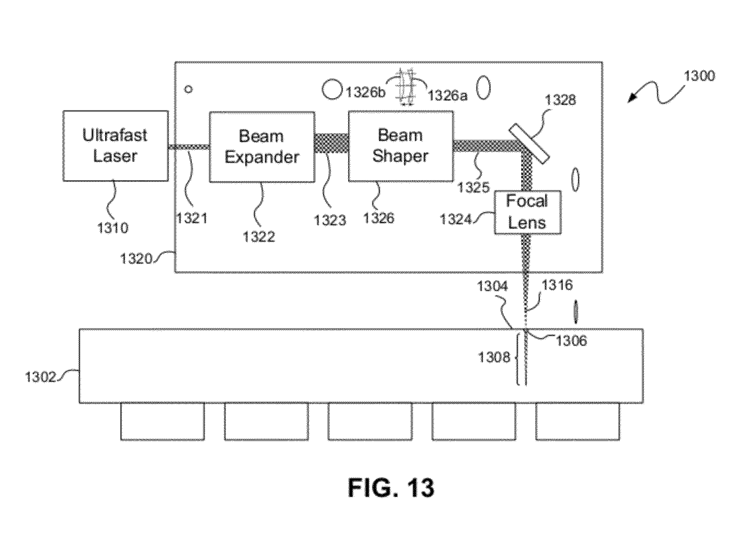

Referring to FIG. 13, another embodiment of a laser machining system 1300 for scribing a workpiece 1302, such as a sapphire substrate of a semiconductor wafer, with extended depth affectation is described in greater detail. The laser machining system 1300 may include an ultrafast laser 1310 capable of emitting ultrashort pulses (e.g., less than 1 ns) at a wavelength capable of passing at least partially through the material and a beam delivery system 1320 capable of providing a well-focused line beam 1316. One embodiment of the beam delivery system 1320 includes a beam expander 1322 for expanding the raw laser beam 1321 from the ultrafast laser 1310 to form an expanded beam 1323, a beam shaper 1326 for shaping the expanded beam 1323 to form an elliptical shaped beam 1325, and a focusing lens 1324 for focusing the elliptical shaped beam 1325 to provide the well-focused line beam 1316 that forms a line beam spot on the workpiece 1302 and has an extended DOF within the workpiece 1302. The beam delivery system 1320 may also include one or more reflectors 1328 to reflect and redirect the laser beam as needed.

As mentioned previously, extended depth affectation scribing involves laser ablating material on the surface 1304 of the workpiece 1302 in an ablation zone 1306 and using a waveguide self-focusing effect to direct the laser beam 1316 from the ablation zone 1306 to an internal location 1308 extending within the workpiece 1302 where crystal damage is caused due to shock, electric fields and/or pressure. The focusing lens 1324 may introduce spherical aberrations as described above with a longitudinal spherical aberration range sufficient to extend the effective DOF into the workpiece 1302.

The beam delivery system 1320 may include beam shaping optics capable of forming a variable elongated astigmatic focal beam spot, for example, as described in greater detail in U.S. Pat. No. 7,388,172, which is fully incorporated herein by reference. The elongated astigmatic focal beam spot has a length in the astigmatic axis that is longer than a width in the focused axis. Such a beam delivery system is capable of controlling the energy density of the variable astigmatic focal beam spot as the length of the spot is varied. The beam shaper 1326 may include, for example, an anamorphic lens system including a cylindrical plano-concave lens 1326a and a cylindrical plano-convex lens 1326b such that varying a distance between these lenses varies the length of the beam spot and the energy density on the workpiece.

The laser machining system 1300 may further modify the beam to improve the quality of the scribe depending upon the application. To avoid epi layer delamination issues in certain applications (e.g., back side scribing), for example, the laser machining system 1300 may provide spatial filtering at the edges of the beam to clean up the point spread function in the narrow direction of the beam.

The beam shaper 1326 may thus be used to vary the energy density of the beam spot on the workpiece 1302 to optimize the fluence and coupling efficiency for a particular material or scribing operation. When performing dual side scribing on a GaN coated sapphire substrate, for example, the energy density of the beam spot may be adjusted higher to optimize scribing of the bare sapphire (i.e., back side scribing) and may be adjusted lower to optimize scribing of the GaN coated sapphire (i.e., front side scribing). In other words, one side of the workpiece may be scribed with the laser beam spot optimized for that side, the workpiece may be flipped, and the other side may be scribed with the laser beam spot optimized for that side. The beam shaper 1326 thus avoids having to adjust the laser power to change the energy density and optimize the fluence.

In other embodiments, a nonlinear optical crystal, such as BBO crystal or beta-BaB₂O₄, may be used as a beam shaper. BBO crystals are known for use with a laser as a frequency-doubling crystal. Because the BBO crystal provides more walk-off than other crystals (e.g., CLBO), a substantially circular beam entering the crystal may become an elliptical beam upon exiting the crystal. Although the walk-off may not be desirable in many applications, this characteristic of the BBO crystal provides a unique advantage in an application where an elliptical shaped beam is desired.

Accordingly, laser machining systems and methods for scribing with extended depth affectation provide several advantages over conventional ablation scribing and stealth scribing techniques. In particular, scribing with extended depth affectation enables scribing a workpiece, such as a sapphire substrate of a semiconductor wafer, with minimal or significantly reduced heat and debris. By reducing or minimizing the heat and debris generated, LEDs may be produced with low electrical damage and light loss and without requiring additional coating and cleaning processes. Scribing with extended depth affectation also facilitates scribing of thicker workpieces and workpieces with opaque coatings or films. Scribing with extended depth affectation also avoids having to use complex and expensive high NA lens and focusing systems in conventional stealth scribing systems. Scribing with extended depth affectation, as described herein, may be accomplished in various types of materials by adjusting processing parameters such as wavelength, pulse duration, pulse energy, and optics.

Consistent with one embodiment, a method of laser scribing a workpiece includes: generating a laser beam with ultrashort pulses having a pulse duration of less than 1 ns; and focusing the laser beam such that an energy density is sufficient to ablate a surface of the substrate at an ablation zone and to change an index of refraction in the workpiece, wherein the beam passes through the ablation zone to an internal location within the workpiece using a waveguide self-focusing effect to cause crystal damage to material of the workpiece at the internal location.

Consistent with another embodiment, a method of laser scribing a workpiece includes: generating a laser beam having a wavelength, a pulse duration, and a pulse energy sufficient to provide nonlinear multiphoton absorption within material of the workpiece; focusing the laser beam using a lens that introduces spherical aberrations with a longitudinal spherical aberration range sufficient to provide an extended depth of field (DOF) within the workpiece such that a single pulse of the laser beam causes an extended depth affectation within the workpiece; and scanning the workpiece with the laser beam such that a series of extended depth affectations are caused by a series of pulses at a series of locations along the workpiece.

Consistent with a further embodiment, a laser machining system includes a laser for generating a laser beam having a wavelength, a pulse duration, and a pulse energy sufficient to provide nonlinear multiphoton absorption within material of the workpiece and a beam delivery system for focusing the laser beam and directing the laser beam toward a workpiece. The beam delivery system includes a beam expander for expanding the laser beam and a lens that introduces spherical aberrations with a longitudinal spherical aberration range sufficient to provide an extended depth of field (DOF) within the workpiece such that a single pulse of the laser beam causes an extended affectation within the workpiece. The laser machining system further includes a workpiece positioning stage for moving the workpiece to scan the laser beam across the workpiece such that a series of pulses form a series of extended affectations within the workpiece.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method of laser scribing a workpiece, the method comprising:
generating a laser beam with ultrashort pulses having a pulse duration of less than 1 ns; and
focusing the laser beam such that an energy density is sufficient to ablate a surface of the substrate at an ablation zone and to change an index of refraction in the workpiece, wherein the beam passes through the ablation zone to an internal location within the workpiece using a waveguide self-focusing effect to cause crystal damage to material of the workpiece at the internal location.

2. The method of claim 1 wherein focusing the laser beam is performed using a lens having a numerical aperture less than 0.8.

3. The method of claim 2 wherein the lens is a lens triplet.

4. The method of claim 2 wherein the lens has a focal length of at least 25 mm.

5. The method of claim 2 wherein the lens provides an effective focusability with a focal depth of about 400 μm and a kerf width of about 3 μm.

6. The method of claim 1 wherein the laser beam has a wavelength to provide nonlinear multiphoton absorption within the material of the workpiece.

7. The method of claim 6 wherein the material is sapphire, and wherein the wavelength is in the UV range.

8. The method of claim 7 wherein generating the laser beam includes generating at least one pulse with a pulse energy of about 60 μJ and a pulse duration of less than about 10 ps.

9. The method of claim 8 wherein generating the laser beam includes generating a plurality of pulses at a repetition rate of about 33.3 kHz, and further comprising scanning the laser beam across the workpiece with a scan speed in a range of about 70 mm/s to 90 mm/s.

10. The method of claim 6 wherein the wavelength is in the IR range.

11. The method of claim 6 wherein the material is sapphire, wherein the wavelength is about 355 nm, and wherein focusing the laser beam is performed using a 25 mm lens triplet with an operating numerical aperture in a range of about 0.15 to 0.2.

12. The method of claim 6 wherein the material is sapphire, wherein the wavelength is about 355 nm, and wherein focusing the laser beam is performed using a 60 mm lens triplet with an operating numerical aperture in a range of about 0.05 to 0.1.

13. The method of claim 1 further comprising scanning the laser beam across the workpiece with a scan speed such that a series of ablation zones and crystal-damaged internal locations are formed by a series of pulses of the laser beam along a scribe line.

14. The method of claim 1 wherein focusing the laser beam is performed using a lens having a numerical aperture less than about 0.5.

15. The method of claim 1 wherein focusing the laser beam provides an extended depth of field to cause crystal damage with a depth of at least about 100 μm into the workpiece.

16. The method of claim 1 wherein the laser beam is focused on the surface of the workpiece with an extended depth of field into the workpiece.

17. The method of claim 1 wherein the laser beam is focused at a focus offset below the surface of the workpiece with an extended depth of field further into the workpiece.

18. The method of claim 1 wherein focusing the laser beam introduces spherical aberrations with a longitudinal spherical aberration range sufficient to extend the depth of field into the workpiece.

19. The method of claim 18 wherein the laser beam is focused at a focus offset below the surface of the workpiece.

20. The method of claim 18 wherein focusing the laser beam includes over-filling an aperture of a lens having a diffraction limited region such that the spherical aberrations are introduced outside of the diffraction limited region.

21. The method of claim 20 wherein the lens is over-filled sufficiently to provide the longitudinal spherical aberration range extending the depth of field into the workpiece while limiting a transverse spherical aberration range.

22. The method of claim 18 wherein a spot size of the laser beam on the surface of the workpiece has a width of less than about 20 μm.

23. The method of claim 1 wherein the laser beam provides a laser zone at the surface of the workpiece with a dimension in a range of about 10-20 μm, and wherein the ablation zone at the surface of the workpiece is less than about 10 μm.

24. The method of claim 1 further comprising:
shaping the laser beam to form a variable elongated focal beam spot on the surface of the substrate.

25. A method of laser scribing a workpiece, the method comprising:
generating a laser beam having a wavelength, a pulse duration, and a pulse energy sufficient to provide nonlinear multiphoton absorption within material of the workpiece;
focusing the laser beam using a lens that introduces spherical aberrations with a longitudinal spherical aberration range sufficient to provide an extended depth of field (DOF) within the workpiece such that a single pulse of the laser beam causes an extended depth affectation within the workpiece; and
scanning the workpiece with the laser beam such that a series of extended depth affectations are caused by a series of pulses at a series of locations along the workpiece.

26. The method of claim 25 wherein the laser beam includes ultrashort pulses with a pulse duration of less than 1 ns.

27. The method of claim 25 wherein the lens includes a diffraction limited region, and wherein focusing the laser beam includes over-filling an aperture of the lens such that the spherical aberrations are introduced outside of the diffraction limited region

28. The method of claim 27 wherein the lens is over-filled sufficiently to provide the longitudinal spherical aberration range extending the depth of field into the workpiece while limiting a transverse spherical aberration range.

29. The method of claim 27 wherein a spot size of the laser beam on the surface of the workpiece has a width of less than about 20 μm.

30. The method of claim 29 wherein the extended affectation extends at least 100 μm into the workpiece.

31. The method of claim 25 wherein the lens has a numerical aperture less than about 0.5.

32. The method of claim 25 wherein the laser beam is focused with a paraxial focal point on the surface of the workpiece.

33. The method of claim 25 wherein the laser beam is focused with a paraxial focal point at a focus offset below the surface of the workpiece.

34. The method of claim 25 wherein the laser beam is focused such that an energy density is sufficient to ablate a surface of the workpiece at an ablation zone.

35. The method of claim 34 wherein the laser beam provides a laser zone at the surface of the workpiece with a dimension in a range of about 10-20 μm, and wherein the ablation zone at the surface of the workpiece is less than about 10 μm.

36. The method of claim 25 wherein the material is sapphire, and wherein the wavelength is in the UV range.

37. The method of claim 25 wherein the material is silicon, and wherein the wavelength is in the IR range.

38. The method of claim 25 wherein the material is glass, and wherein the wavelength is in the visible range.

39. The method of claim 25 wherein the workpiece is scanned with the laser beam such that the series of extended depth affectations are caused by a series of single pulses at respective locations.

40. A laser machining system comprising:
a laser for generating a laser beam having a wavelength, a pulse duration, and a pulse energy sufficient to provide nonlinear multiphoton absorption within material of the workpiece;
a beam delivery system for focusing the laser beam and directing the laser beam toward a workpiece, the beam delivery system including a beam expander for expanding the laser beam and a lens that introduces spherical aberrations with a longitudinal spherical aberration range sufficient to provide an extended depth of field (DOF) within the workpiece such that a single pulse of the laser beam causes an extended affectation within the workpiece; and
a workpiece positioning stage for moving the workpiece to scan the laser beam across the workpiece such that a series of pulses form a series of extended affectations within the workpiece.

41. The laser machining system of claim 40 wherein the laser is configured to generate a laser beam including ultrashort pulses with a pulse duration of less than 1 ns.

42. The laser machining system of claim 40 wherein the lens has a numerical aperture less than about 0.5.

43. The laser machining system of claim 40 wherein the lens includes a lens triplet having a focal length of at least about 25 mm and a numerical aperture less than about 0.5.
